(19) United States
(12) Patent Application Publication
(10) Pub. No.: US 2020/0305574 A1
(43) Pub. Date: Oct. 1, 2020

(54) DISPENSING AND APPLICATION HEAD

(71) Applicant: APTAR FRANCE SAS, LE NEUBOURG (FR)

(72) Inventors: Emmanuel PEREZ, Boissey-le-chatel (FR); Francis MOREAU, Sotteville Les Rouen (FR); Benoit BRISEMUR, Bernay (FR)

(73) Assignee: APTAR FRANCE SAS, LE NEUBOURG (FR)

(21) Appl. No.: 16/651,652

(22) PCT Filed: Sep. 29, 2017
(86) PCT No.: PCT/FR2017/052681

§ 371 Date: Mar. 27, 2020

(51) Int. Cl. A45D 34/04; B05B 11/00

(52) U.S. Cl. CPC A45D 34/04; B05B 11/0035; B05B 11/00416; B05B 11/0072; B05B 11/0089

(57) ABSTRACT

A dispenser and applicator head (3) for associating with a dispenser unit (2), such as a pump, the head, having a connection stub (4t) for connecting to the dispenser unit (2); an assembly core (4n) connected to the connection stub (4t); a fluid applicator pad (5) mounted on the assembly core (4n) for coming into contact with a target surface; and a dispenser channel (Ca, Cs) that passes through the connection stub (4t) and the assembly core (4) and that forms a dispenser orifice (50). The dispenser channel (Ca, Cs) includes an outlet segment (Cs) formed jointly by the assembly core (4n) and by the fluid applicator pad (5).

The present invention relates to a dispenser and applicator head for associating with a dispenser unit, such as a pump, a valve, a squeezable tube, etc. The head comprises a connection stub for connecting to the dispenser unit, an assembly core that is connected to the connection stub, and a fluid applicator pad that is for coming into contact with a target surface, such as the skin, so as to apply the fluid onto the target surface. The applicator pad is mounted on the assembly core. The head also defines a dispenser channel that passes through the connection stub and the assembly core and that defines a dispenser orifice. The present invention also defines a fluid dispenser including such a dispenser and applicator head. Advantageous fields of application of the present invention are the fields of cosmetics, perfumery, and pharmacy.

In the prior art, Document U.S. Pat. No. 7,883,287 is already known, which describes an applicator pad that is mounted on an assembly core that is connected to a connection stub that is mounted on a fluid reservoir. A fluid dispenser channel passes through the core and the stub, which channel opens out via a dispenser orifice that is formed in the pad. In order to avoid any contact between the fluid and the pad at the dispenser channel, the core includes a plastics insert that passes through the pad and that defines the dispenser channel.

In the prior art, Document U.S. Pat. No. 9,277,798 is also known, which describes a pad made of Zamac® that has a fluid dispenser channel passing therethrough. The pad presents a minimum thickness in the vicinity of the channel so as to make it easier to surface treat the pad.

From those two prior-art documents, it should be observed that passing the dispenser channel through the applicator pad is complicated.

In the prior art, Document U.S. Pat. No. 9,498,042 is also known which describes a dispenser and applicator head including an assembly core and an applicator pad that is mounted on the core. A fluid dispenser channel passes through the core and opens out through a dispenser orifice that is formed in the core, at a distance from the pad.

From that prior-art document, it should be observed that passing the dispenser channel beside the applicator pad is also complicated. Specifically, it is necessary to offset or divert the dispenser channel so as to avoid the applicator pad.

An object of the present invention is to remedy the above-mentioned drawbacks of the prior art by defining a dispenser and applicator head having a structure that makes it easier both to form the dispenser channel and to design the applicator pad, without complicating the operation of mounting the pad on the core.

To do this, the present invention proposes that the dispenser channel includes an outlet segment that is formed jointly by the assembly core and by the fluid applicator pad. Thus, the outlet segment runs along both an outer edge of the pad and also an outer edge of the core. It can also be said that the outlet segment includes facing inner walls that are formed respectively by the assembly core and by the fluid applicator pad. The outlet segment is formed between the core and the pad. It is formed only when the pad is mounted on the core. Thus, a mere gap between the core and the pad suffices to form the outlet segment. As a result, the pad may be in the form of a solid part that does not have any passage passing therethrough. Treating the surface of the pad is made much easier, since there are no locations that are difficult to access, as is the situation with a through passage. On the assembly core, forming the dispenser channel is also simpler, since it suffices to run along the pad, and no longer to go round it, as is the situation in Document U.S. Pat. No. 9,498,042.

According to an advantageous characteristic, the dispenser orifice is formed jointly by the assembly core and by the fluid applicator pad. Thus, the outlet segment opens out between the core and the pad.

In an advantageous embodiment, the dispenser orifice extends over the outer periphery of the fluid applicator pad. The dispenser orifice may be annular and may thus extend all around the fluid applicator pad. The assembly core and the fluid applicator pad may come into leaktight contact at the dispenser orifice, so as to form a self-sealing slot that is opened by the fluid under pressure. In this configuration, the core may be made out of a flexible material that deforms under the pressure exerted by the fluid. It is also possible to envisage making an applicator pad out of a flexible material.

In another advantageous aspect of the invention, the connection stub and the assembly core define a longitudinal axis X, the dispenser channel including an axial segment that passes through the connection stub and the assembly core, extending along the longitudinal axis X. Thus, the axial segment may be both centered and rectilinear, which makes it easier to form, in particular by molding merely by means of a straight pin. The axial segment is then connected downstream to the outlet segment, formed between the core and the pad.

In a practical embodiment, the assembly core may form a reception housing for receiving the fluid applicator pad, advantageously by snap-fastening. Advantageously, the fluid applicator pad may be circularly symmetrical. No orientation of the pad is thus necessary while mounting it on the core.

In another advantageous embodiment, the connection stub and the assembly core define a longitudinal axis X, the dispenser channel extending along the longitudinal axis X of the connection stub to the dispenser orifice.

Advantageously, the head defines a longitudinal axis X that extends at least through the connection stub and the assembly core, the applicator pad being mechanically fitted and mounted on the assembly core along a mounting axis that extends transversally relative to the longitudinal axis.

In a preferred embodiment, the applicator pad is made out of a heat-transfer material, such as metal or ceramic, advantageously having a specific gravity greater than 2, so as to impart a cold sensation on contact with the skin. Materials having a specific gravity lying in the range 4 to 8 are the most effective.

In a practical embodiment, the assembly core is connected to the connection stub by means of a flexible interconnection section through which the dispenser channel also passes. The flexible section can also considered as being formed by the stub or by the core, or by both the stub and the core. The flexible section may merely be in the form of a narrowing that is suitable for imparting the ability to deform.

Advantageously, the assembly core and the connection stub are made as a single-piece part, through which only the dispenser channel advantageously passes. The assembly core and the connection stub can be made by bi-injection.

The spirit of the invention resides in making a portion of the dispenser channel, and at least the dispenser orifice, between the core and the pad, so as to make it easier to make the pad and to treat its surface, and so as to enable the dispenser channel to be formed through the stub and the core. When the pad provides a thermal effect (hot or cold), temperature of the fluid is varied as a result of the outlet segment running along the pad.

The invention is described more fully below with reference to the accompanying drawings which show three embodiments of the invention by way of non-limiting example.

In the figures:

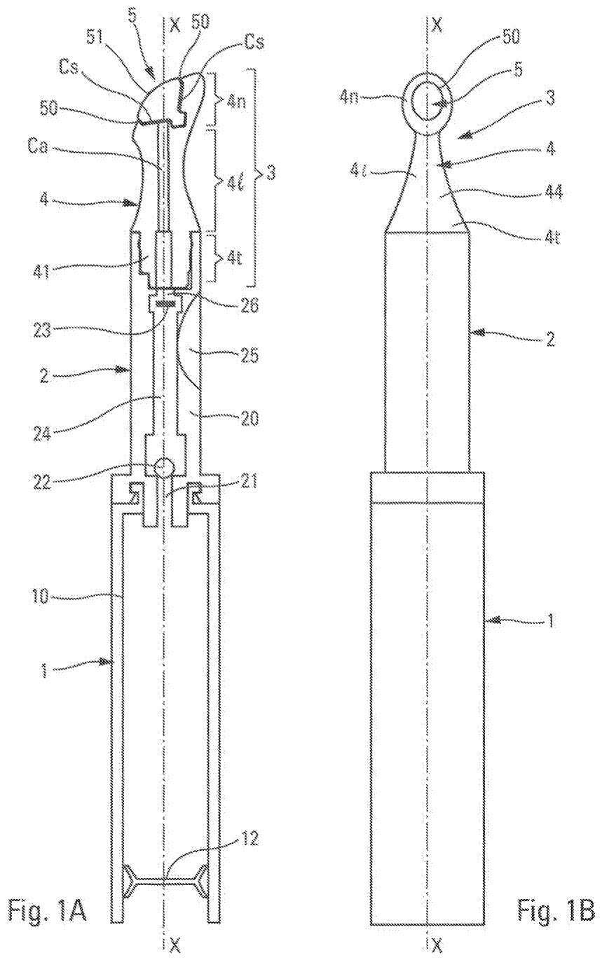

FIG. 1A is a diagrammatic vertical section view through a dispenser in a first embodiment of the invention;

FIG. 1A is a front view of the FIG. 1A dispenser;

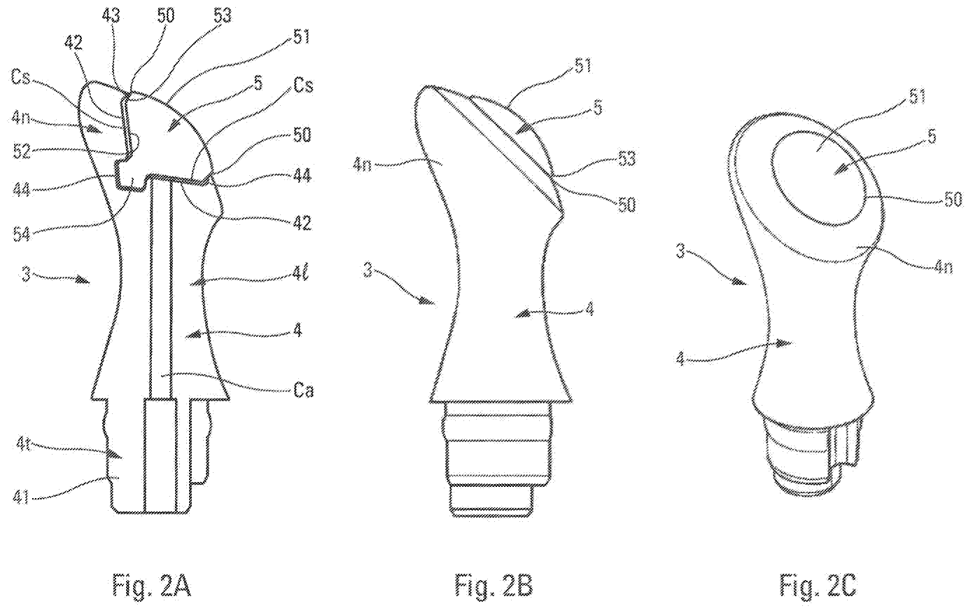

FIG. 2A is a vertical section view through the dispenser head in FIGS. 1A and 1B;

FIG. 2B is a side view of the FIG. 2A head;

FIG. 2C is a perspective view of the head in FIGS. 2A and 2B;

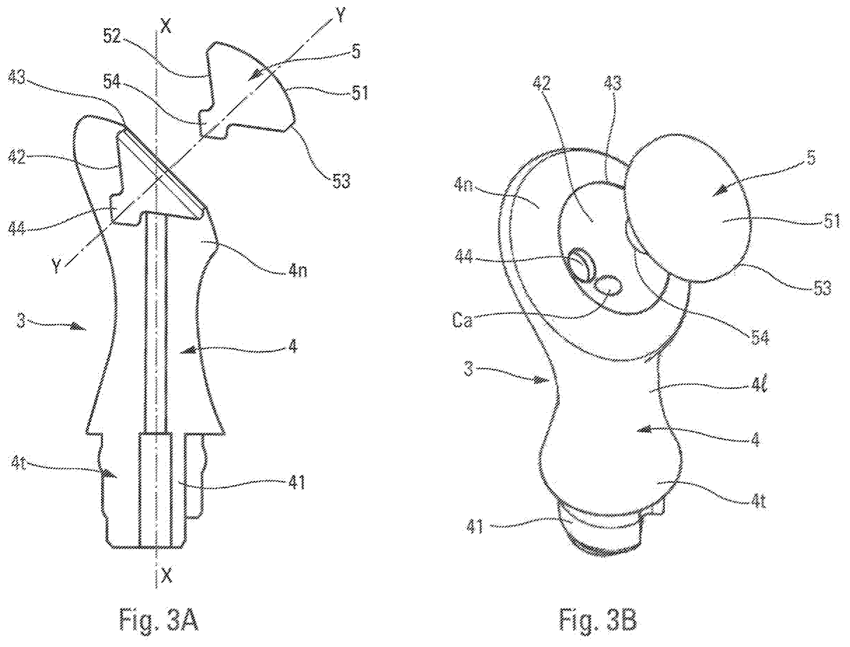

FIG. 3A is an exploded vertical section view of the head in FIGS. 2A, 2B, and 2C;

FIG. 3B is an exploded perspective view of the FIG. 3A head;

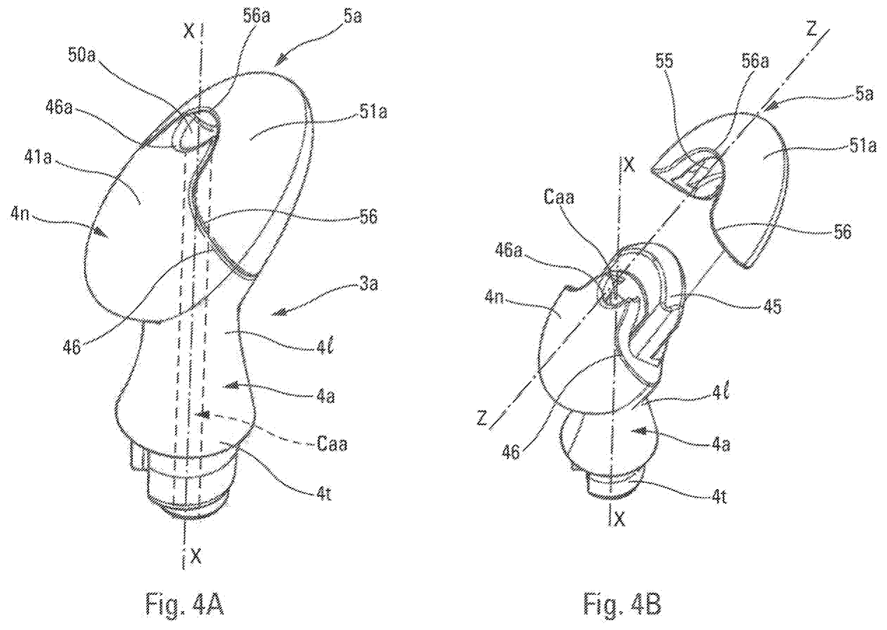

FIG. 4A is a perspective view of a dispenser head in a second embodiment of the invention;

FIG. 4B is an exploded perspective view of the FIG. 4A head;

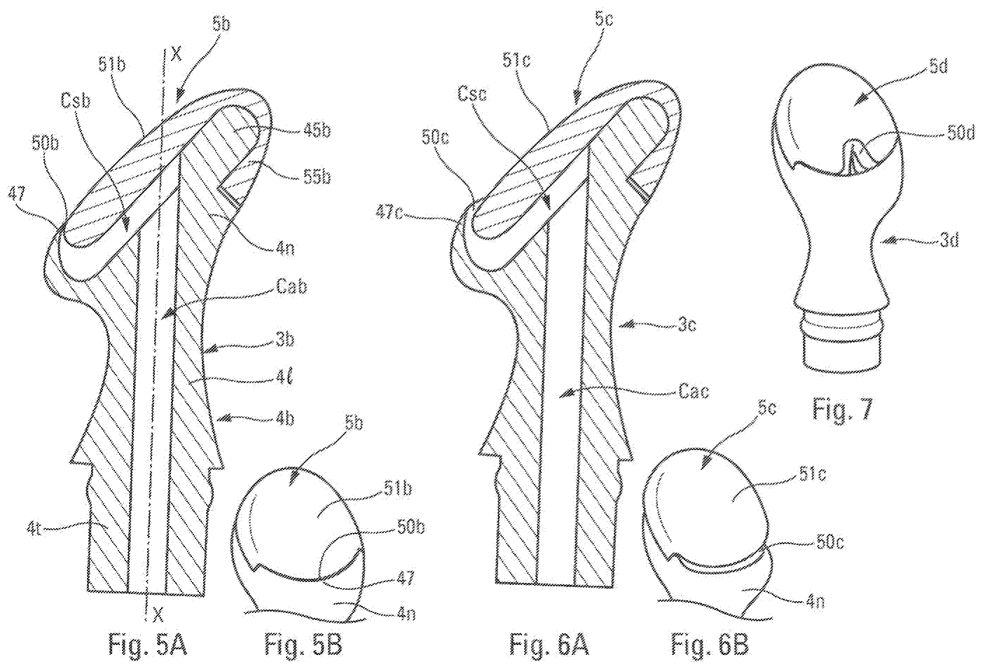

FIG. 5A is a vertical section view through a dispenser and applicator head in the third embodiment;

FIG. 5B is a simplified perspective view of the FIG. 5A head;

FIG. 6A is a vertical section view through a dispenser and applicator head in a variant of the third embodiment;

FIG. 6B is a simplified perspective view of the FIG. 6A head; and

FIG. 7 is a simplified perspective view of another variant of the third embodiment.

Reference is made initially to FIGS. 1A and 1B in order to describe very generally the structure of the fluid dispenser in the first embodiment of the invention. The dispenser essentially comprises three component elements, namely a fluid reservoir 1, a dispenser unit 2 that is a laterally-actuated pump in this embodiment, and a dispenser head 3 that is constituted by an endpiece 4 associated with an applicator pad 5.

The fluid reservoir 1 may be of any kind (with or without an air inlet), of any shape, and made out of various appropriate materials (flexible or rigid). In the field of cosmetics, it is common to use a particular reservoir, as shown in FIG. 1A, that comprises a cylindrical slide cylinder 10 associated with a follower piston 12 that moves along the cylinder 10 as fluid is removed therefrom. This type of reservoir makes it possible to keep the fluid out of contact with the outside air. When the reservoir is full, the follower piston 12 is located at an end of the cylinder 10 that is remote from the other end of the cylinder where a neck 11 is formed that defines an opening that puts the inside of the reservoir into communication with the outside. This design is entirely conventional for a reservoir of the follower-piston type, but other types of reservoir could be used without going beyond the ambit of the invention.

The pump 2 is a laterally-actuated pump that includes a pump body 20 that, at its bottom end, defines a fluid inlet 21 that is in communication with the reservoir 1. The pump 2 includes an inlet valve 22 and an outlet valve 23 between which there is formed a pump chamber 24 including a laterally-actuated wall 25 that makes it possible to reduce the internal volume of the chamber 24. It should be observed that the outlet 26 of the pump 2 is stationary and situated on the axis of the pump and of the dispenser. Other types of pump can also be used in the context of the invention. On peut même utiliser une valve ou un tube souple à la place de la pompe.

The head 3 is mounted on the outlet 26 of the pump 2 so that it is not subjected to any movement while the pump 2 is being actuated by the lateral pusher 25. As mentioned above, the dispenser head 3 comprises an endpiece 4 associated with an applicator pad 5. The endpiece 4 presents a longitudinal major axis X and is advantageously made as a single-piece part. It comprises a connection stub 4t, an interconnection section 4l, and an assembly core 4n for mounting the applicator pad 5. The interconnection section 4l is optional, or it can be considered as forming an integral part of the stub 4t and/or of the core 4n. The interconnection section 4l may be rigid or deformable, in particular as a result of it forming a narrowing between the stub and the core. When it is deformable, this makes it possible to impart a certain degree of freedom of movement to the pad 5. The connection stub 4t forms a connection sleeve 41 that is force-fitted or snap-fastened in the top portion of the pump 2 that defines the outlet 26.

The endpiece 4 is made out of plastics material (e.g. polyethylene (PE) or polypropylene (PP)), whereas the applicator pad 5 is advantageously made out of a rigid or hard heat-transfer material, such as metal, ceramic, an inorganic material, etc. that is suitable for imparting a cold sensation on contact with the skin. Preferably, the piece 5 presents considerable wall thickness so as to increase its thermal inertia. The specific gravity of the heat-transfer material is greater than 2, and preferably lies in the range 4 to 8. It is also possible to use a pad 5 that is made out of a flexible material, such as a filled elastomer. A non-heat-transfer pad, e.g. made out of PE or PP, can also be used.

The assembly core 4n forms a reception housing L in which the applicator pad 5 is engaged or fitted. The housing L includes a flexible annular lip 43 at its inlet, and a fastener chamber 44 in its rear wall. Between the chamber 44 and the lip 43, the housing defines a frustoconical wall 42 having a solid angle of about 90°, or a little more, for ease of unmolding.

Advantageously, the applicator pad 5 is circularly symmetrical and is of shape that is similar to a spinning top. More precisely, the pad 5 includes an applicator surface 51 that may be plane or rounded (convex). The applicator surface has the shape of a convex disk or of a flattened dome. The pad also includes a frustoconical wall 52 of shape that is similar or identical to the shape 42 of the housing L. Between the applicator surface 51 and the frustoconical wall 52, the pad forms an edge face 53 that is substantially cylindrical, and against which the flexible lip 43 bears in such a manner as to create a leaktight annular contact. Finally, the pad 5 includes a fastener pin 54 that is force-fitted, adhesively-bonded, heat-sealed, or snap-fastened in the fastener chamber 44 of the housing L.

In FIG. 2A, it should be observed that a gap exists between the two facing frustoconical walls 42 and 52, which gap extends from the fastener chamber 44 to the flexible lip 43 that is in leaktight bearing against the edge face 53.

The dispenser and applicator head 3 also includes an internal dispenser duct that enables the fluid to be conveyed from the outlet 26 to a dispenser orifice 50 that, in this embodiment, is formed at the leaktight contact between the lip 43 and the edge face 53. The dispenser orifice 50 extends all around the pad 5 and, as a result, presents an annular shape. It behaves as a self-sealing slot that is closed at rest, and that opens so as to create an outlet passage under the pressure exerted by the fluid. The dispenser orifice 50 forms the outlet of the dispenser channel C.

Upstream from the dispenser orifice 50, the dispenser channel includes an outlet segment Cs that is formed by the gap between the two facing frustoconical walls 42 and 52.

Further upstream, the dispenser channel includes an axial segment Ca that extends through the endpiece 3, advantageously in central and rectilinear manner. The axial segment Ca opens out into the housing L through the frustoconical wall 42. Thus, the fluid driven under pressure through the outlet 26 of the pump flows through the axial segment Ca, then through the outlet segment Cs, and then forces the flexible lip 43 to open the dispenser orifice 50 in order to arrive finally around the pad 5.

It should be observed that the outlet segment Cs and the dispenser orifice 50 are formed jointly by the assembly core 4n and by the pad 5. In other words, the outlet segment Cs includes facing inner walls that are formed respectively by the assembly core 4n and by the applicator pad 5. The dispenser orifice 50 can be considered as constituting the final or end portion of the outlet segment Cs.

It should also be observed that the endpiece 4 is of a design that is very simple, with the axial segment Ca centered and straight, and the housing L wide open and well oriented so as to guarantee easy unmolding. In addition, the pad 5 is completely circularly symmetrical and does not include any through passage. Next, the outlet segment Cs extends over a large area of the pad 5, so that the fluid can rapidly reach the temperature of the pad. In addition, the flexible lip 43 acts to close the outlet, enabling the fluid in the head 3 to be better preserved. Finally, it is very easy to automate mounting the pad 5 in the housing L along a mounting axis Y that is transverse to the axis X.

In a variant, it is possible to eliminate the flexible lip 43, such that the dispenser orifice would thus be formed by an annular slot that is open continuously. It is also possible to provide a rigid lip that is interrupted locally so as to form one or more dispenser orifices. The outlet segment Cs is formed between frustoconical walls 42 and 52: other shapes could be envisaged for the facing walls, providing they define between them a gap that leads from the axial segment Ca to the dispenser orifice.

Reference is made below to FIGS. 4A and 4B, which show a dispenser and applicator head 3a in a second embodiment of the invention. The single-piece endpiece 4a includes a connection stub 4t and an interconnection section 4l that may be identical or similar to the connection stub and interconnection section of the first embodiment in FIGS. 1A to 3B. The assembly core 4n is different in that it forms a first large applicator surface portion 41a that is defined in its top end by a shaped edge 46 that presents a notch 46a that forms a portion of a dispenser orifice 50a. In FIG. 4B, it can be seen that the core 4n includes a mounting lug 45 for mounting the applicator pad 5a. The lug 45 and the large applicator surface portion 41a present an orientation that is sloping relative to the longitudinal axis X of the endpiece 3a.

In this second embodiment, the applicator pad 5a is in the form of a rounded cap or cover that internally defines a mounting housing 55 that is adapted to receive the mounting lug 45. The pad 5a defines a second large applicator surface portion 51a that is defined at its bottom end by a complementary shaped edge 56 that is complementary to the shaped edge 46 of the core 4n, except at the notch 46a, where the complementary shaped edge 56 is offset at 56a from the notch 46a so as to form another portion of a dispenser orifice 50a. Thus, the dispenser orifice 50a is formed between the core 4n and the pad 5a, whenever the pad 5a is fitted on the core 4n by being moved in sliding along a mounting axis Z that intersects the longitudinal axis X.

It should be observed that a dispenser channel Caa (shown by dashed lines in FIG. 4A) passes through the endpiece 3a, which channel is both centered on the axis X and also rectilinear from one end to the other, such that the dispenser orifice 50a is situated on the axis X. In addition, the dispenser orifice 50a may be considered as the final outlet segment of the dispenser channel Caa.

The applicator surface of the head 3a is formed jointly by the core 4n and by the pad 5a, substantially in equal parts. The edges 46 and 56 meet in such a manner as to create surface continuity. It can be said that the pad 5a completes the core 4n, and vice versa. They co-operate with each other to form a kind of rounded pebble that does not present any sharp edges.

FIGS. 5A and 5B show a dispenser and applicator head 3b in a third embodiment of the invention. The single-piece endpiece 4b includes a connection stub 4t and an interconnection section 4l that may be identical or similar to the connection stub and interconnection section of the first and second embodiments. The assembly core 4n includes a mounting lug 45b for mounting the applicator pad 5b, and a bottom flexible lip 47 that comes into leaktight contact with a bottom edge of the pad 5b, thereby forming a self-sealing slot, as in the first embodiment.

In this third embodiment, the applicator pad 5b is also in the form of a rounded cap or cover that internally defines a mounting housing 55b that is adapted to receive the mounting lug 45b. The pad 5b and the core 4n present an orientation that slopes relative to the longitudinal axis of the endpiece 4b. The pad 5a is fitted on the core 4n by being moved in sliding along a mounting axis that intersects the longitudinal axis X.

A dispenser channel segment Cab passes through the endpiece 4b, which channel is both centered on the axis X and also rectilinear. The segment Cab opens out downstream into an outlet segment Csb that is formed jointly by the core 4n and by an inside face of the pad 5b. The segment Csb extends downwards as far as the bottom lip 47 that is in leaktight flexible bearing against the pad 5b. When the fluid under pressure is driven through the head 3b, it flows initially through the axial segment Cab, then through the outlet segment Csb, and deforms the lip 47 that lifts off the pad 5b so as to form a dispenser orifice 50b.

FIGS. 6A and 6B show a variant embodiment of FIGS. 5A and 5B. The endpiece 3c and the pad 5c may be identical or similar to the endpiece and pad in FIGS. 5A and 5B, except that the core 4n no longer forms a flexible lip 47 that bears in leaktight manner against the pad 5b, but is a rigid edge 47c that is arranged at a distance from the pad 5c, so as to form between them a dispenser orifice 50c in the form of an elongate curved slot.

FIG. 7 shows a variant embodiment of FIGS. 6A and 6B, that is characterized by the fact that the dispenser orifice 50d is formed by a local indentation of the pad 5d that is not in contact with the core.

In all of the embodiments described above, at least one portion of the dispenser channel is formed jointly by the assembly core and by the applicator pad, this portion of the channel possibly being limited to the dispenser orifice only, as in the embodiment in FIGS. 4A and 4B.

In all of the embodiments described above, the dispenser channel never passes through the applicator pad, but runs along it. It is thus easier to treat the pad by applying an inert coating thereto, which is necessary in particular when it is made out of Zamac®. Given that all of the surfaces of the pad are external surfaces that are easily accessible, the surface treatment can be complete and uniform.

In all of the embodiments described above, the dispenser channel is rectilinear and centered axially in the endpiece. It is only the outlet segment that may extend away from the axis.

In all of the embodiments described above, the dispenser orifice opens out via an outer periphery of the applicator pad. It may be considered as the end portion of the outlet segment.

The dispenser orifice may be situated on the longitudinal axis of the head, as in the embodiment in FIGS. 4A and 4B, or it may be offset relative to this axis. The dispenser orifice may be localized as in the embodiments in FIGS. 4A, 4B, and 7, open and elongate as in the embodiment in FIGS. 6A and 6B, closed and elongate as in the embodiment in FIGS. 5A and 5B, or even open or closed and annular as in the embodiment in FIGS. 1A and 3B.

In all of the embodiments described above, the connection stub is connected directly or indirectly to the assembly core. The interconnection section is rigid or flexible. The endpiece is preferably a single-piece part, made out of a single material, but designs involving multi-material assemblies or bi-injection are also possible.

1.-16. (canceled)

17. A dispenser and applicator head (3; 3a; 3b; 3c; 3d) for associating with a dispenser unit (2), such as a pump, a valve, or a squeezable tube, the head comprising:
a connection stub (4t) for connecting to the dispenser unit (2);
an assembly core (4n) that is connected to the connection stub (4t);
a fluid applicator pad (5; 5a; 5b; 5c; 5d) that is mounted on the assembly core (4n) and that is for coming into contact with a target surface, such as the skin, so as to apply the fluid onto the target surface;
a dispenser channel (Ca, Cs; Caa; Cab, Csb; Cac, Csc) that passes through the connection stub (4t) and the assembly core (4) and that forms a dispenser orifice (50; 50a; 50b; 50c; 50d), the dispenser channel (Ca, Cs; Caa; Cab, Csb; Cac, Csc) including an outlet segment (Cs; 50a; Csb; Csc) that is formed jointly by the assembly core (4n) and by the fluid applicator pad (5; 5a; 5b; 5c; 5d);
the dispenser and applicator head being characterized in that the connection stub (4t) and the assembly core (4n) define a longitudinal axis X, the dispenser channel (Caa) extending along the longitudinal axis X of the connection stub (4t) to the dispenser orifice (50a).

18. A head according to claim 17, wherein the outlet segment (Cs; 50a; Csb; Csc) includes facing inner walls that are formed respectively by the assembly core (4n) and by the fluid applicator pad (5; 5a; 5b; 5c; 5d).

19. A head according to claim 17, wherein the dispenser orifice (50; 50a; 50b; 50c; 50d) is formed jointly by the assembly core (4n) and by the fluid applicator pad (5; 5a; 5b; 5c; 5d).

20. A head according to claim 17, wherein the dispenser orifice (50; 50a; 50b; 50c; 50_{d}) extends over the outer periphery of the fluid applicator pad (5; 5a; 5b; 5c; 5d).

21. A head according to claim 17, wherein the connection stub (4t) and the assembly core (4n) define a longitudinal axis X, the dispenser channel (Ca, Cs; Caa; Cab, Csb; Cac, Csc) including an axial segment (Ca; Caa; Cab; Cac) that passes through the connection stub (4t) and the assembly core (4n), extending along the longitudinal axis X.

22. A head according to claim 21, wherein the axial segment (Ca; Caa; Cab; Cac) is connected downstream to the outlet segment (Cs; 50a; Csb; Csc).

23. A head according to claim 17, the head defining a longitudinal axis X that extends at least through the connection stub (4t) and the assembly core (4n), the applicator pad (5; 5a; 5b; 5c; 5d) being mechanically fitted and mounted on the assembly core (4n) along a mounting axis Y; Z that extends transversally relative to the longitudinal axis X.

24. A head according to claim 17, wherein the applicator pad (5; 5a; 5b; 5c; 5d) is made out of a heat-transfer material, such as metal or ceramic, advantageously having a specific gravity greater than 2, so as to impart a cold sensation on contact with the skin.

25. A head according to claim 17, wherein the assembly core (4n) is connected to the connection stub (4t) by means of a flexible interconnection section (4t) through which the dispenser channel (Ca, Cs; Caa; Cab, Csb; Cac, Csc) also passes.

26. A head according to claim 17, wherein the assembly core (4n) and the connection stub (4t) are made as a single-piece part, through which only the dispenser channel (Ca, Cs; Caa; Cab, Csb; Cac, Csc) advantageously passes.

27. A head according to claim 17, wherein the assembly core (4n) and the applicator pad (5; 5a; 5b; 5c; 5d) co-operate with each other to form an applicator surface for coming into contact with a target surface.
